(19) United States
(12) Patent Application Publication
(10) Pub. No.: US 2025/0077254 A1
(43) Pub. Date: Mar. 6, 2025

(54) METHODS AND SYSTEMS THAT MANAGE CLOUD-COMPUTING INFRASTRUCTURE BY IDEMPOTENT APPLICATION OF DATA SPECIFICATIONS

(71) Applicant: VMware LLC, Palo Alto, CA (US)

(72) Inventors: Gareth Greenaway, Palo Alto, CA (US); Caleb Beard, Palo Alto, CA (US); Megan Withite, Palo Alto, CA (US); Thomas Phipps, Palo Alto, CA (US)

(73) Assignee: VMware LLC, Palo Alto, CA (US)

(21) Appl. No.: 18/382,329

(22) Filed: Oct. 20, 2023

Related U.S. Application Data
(60) Provisional application No. 63/535,257, filed on Aug. 29, 2023.

(51) Int. Cl. G06F 9/455

(52) U.S. Cl. CPC G06F 9/45558; G06F 2009/4557

(57) ABSTRACT

The current document is directed to a cloud-infrastructure-management service that allows users and upstream management systems to define and deploy infrastructure, such as virtual networks, virtual machines, load balancers, and connection topologies, within cloud-computing systems. The cloud-infrastructure-management service includes a describe state module that includes a describe function that generates a configuration file that specifies the current state of a target server running a server-side cloud-infrastructure-management service.

### CROSS-REFERENCE TO RELATED APPLICATION

This application claims the benefit of Provisional Application No. 63/535,057, on Aug. 28, 2023.

### TECHNICAL FIELD

The current document is directed to distributed-computer-systems and, in particular, to a cloud-infrastructure-management service that allows users and upstream applications to define and deploy cloud-based infrastructure, such as virtual networks, virtual machines, load balancers, and connection topologies.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to a cloud-infrastructure-management service that allows users and upstream management systems to define and deploy infrastructure, such as virtual networks, virtual machines, load balancers, and connection topologies, within cloud-computing systems. The cloud-infrastructure-management service includes a describe state module that includes a describe function that generates a configuration file that specifies the current state of a target server running a server-side cloud-infrastructure-management service.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIGS. 8A-D illustrate the YAML Ain′t Markup Language (“YAML”) data serialization language.

FIG. 9 illustrates certain features provided by the Jinja template engine that are used, in addition to YAML, for representing infrastructure in SLS documents.

FIGS. 10A-F illustrate the Salt cloud-infrastructure-management service.

FIGS. 11A-B illustrate the Salt state tree.

FIG. 12 FIG. 12 illustrates the contents of SLS state files.

FIG. 13 shows init.SLS and server.SLS files for a secure-shell state module.

FIG. 14 illustrates a state.apply operation carried out by a Salt master.

FIG. 15 illustrates a basis for state enforcement and IaC cloud-infrastructure configuration and management.

FIG. 16 illustrates additions to the Salt service that provide for the currently disclosed improvements to the Salt service.

FIGS. 17A-D provide control-flow diagrams that represent implementations of the describe-state-module functions in the additional describe state module discussed above with reference to FIG. 16.

FIG. 18 illustrates an additional operation that may be carried out by the Salt service with respect to the SLS state files and top.sls files created for target minions via the describe-state-module functions discussed above.

### DETAILED DESCRIPTION

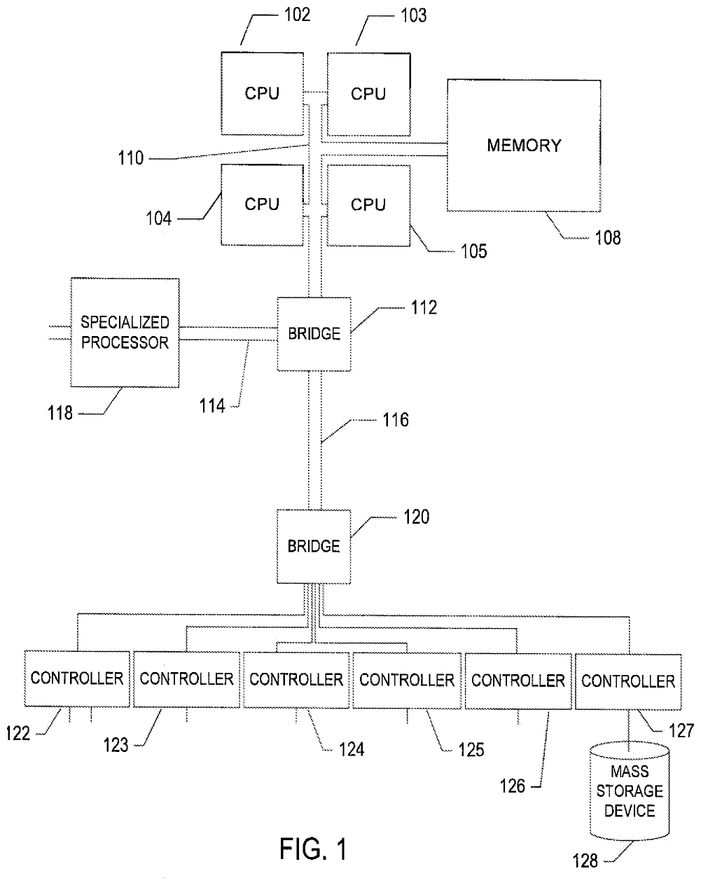

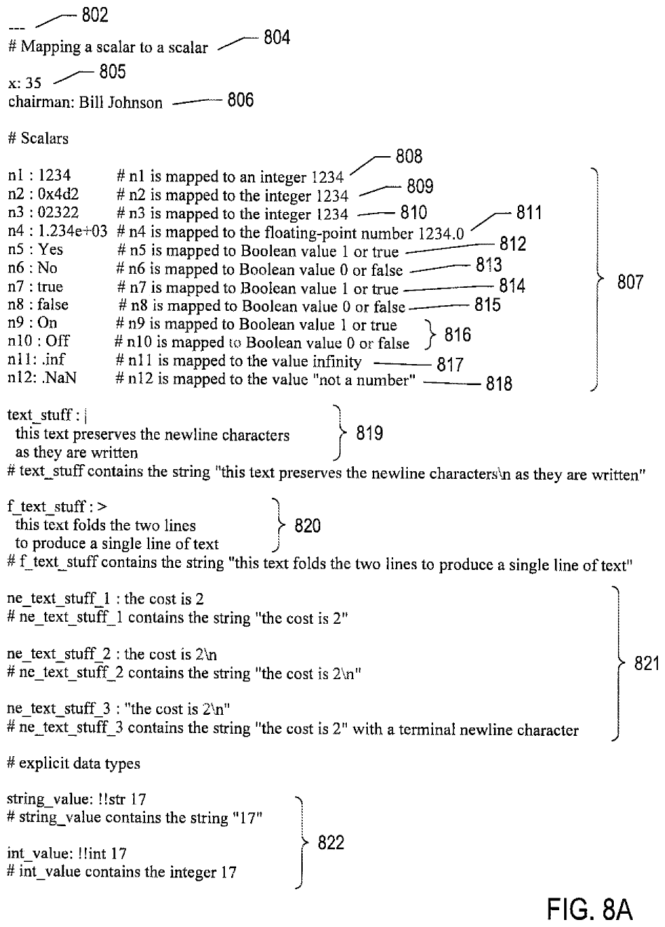

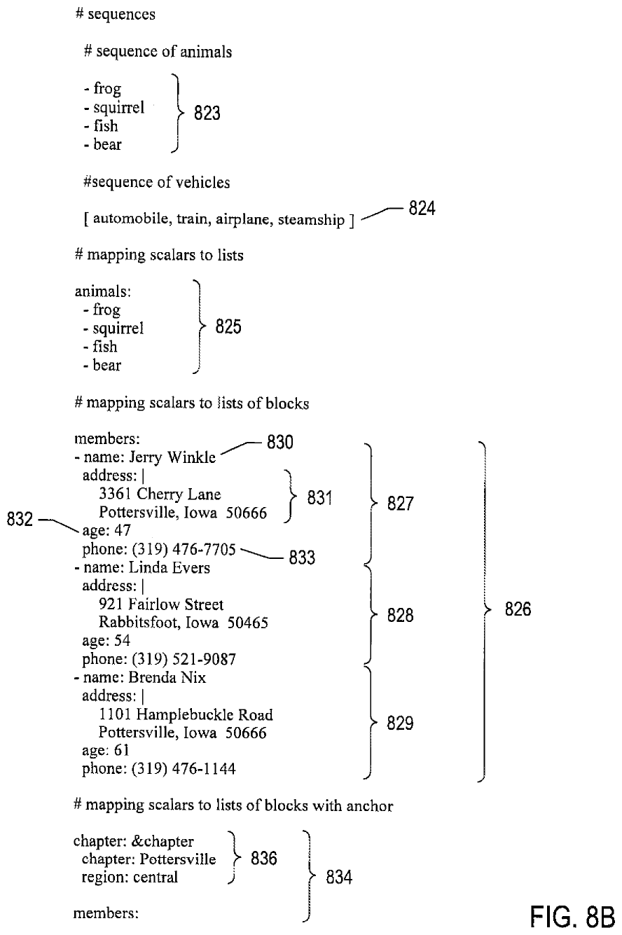

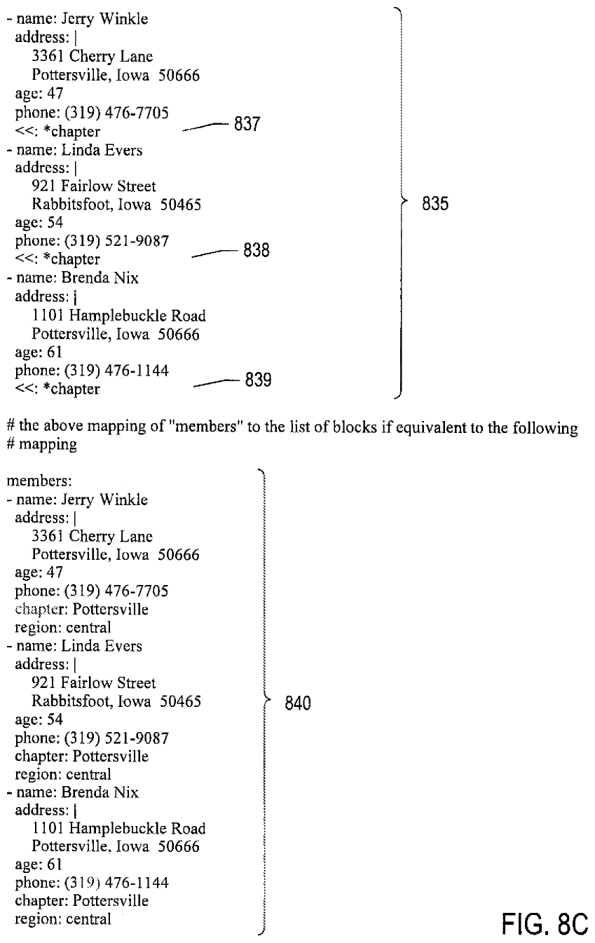

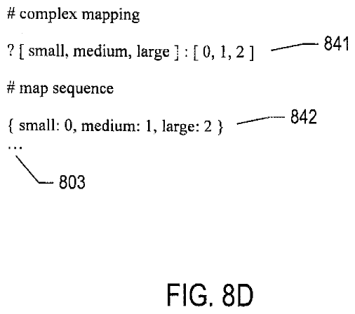

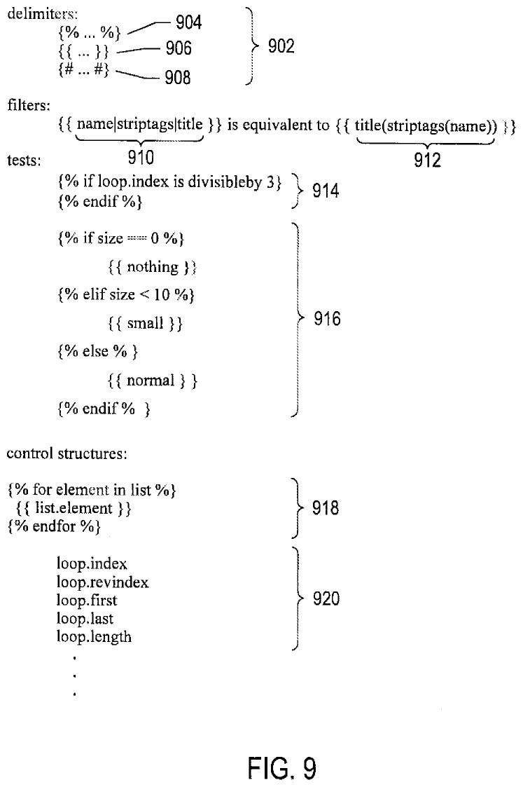

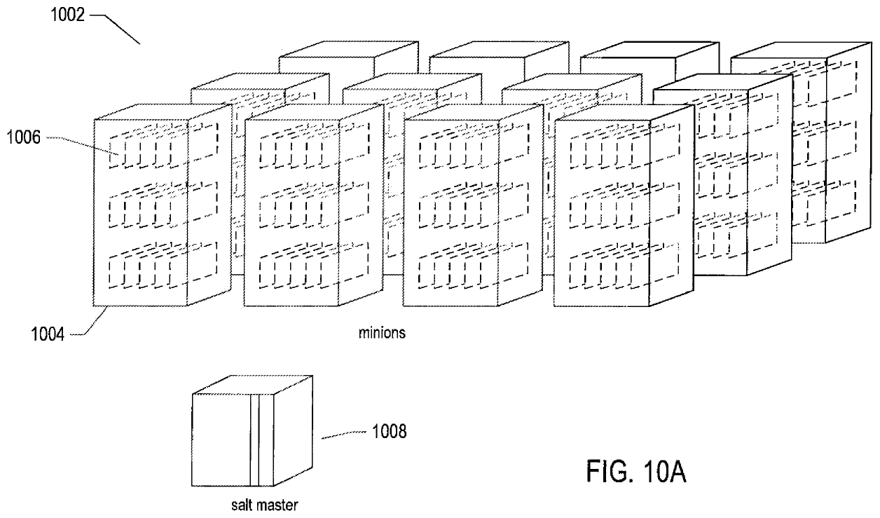

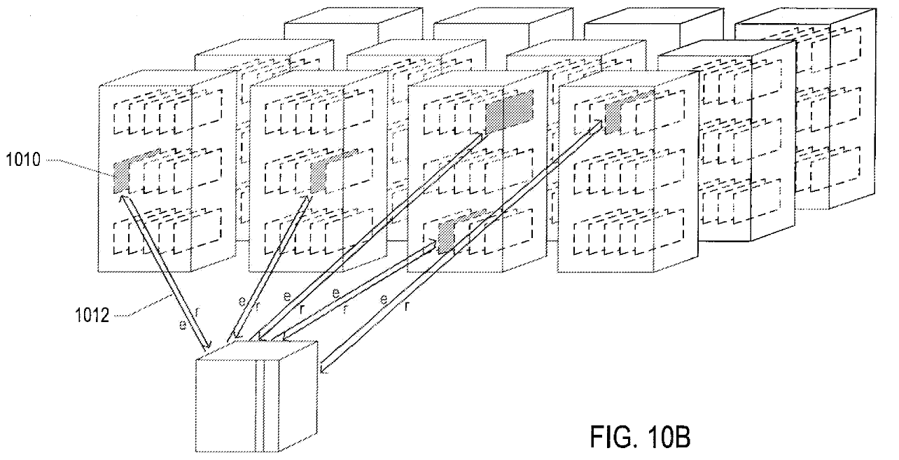

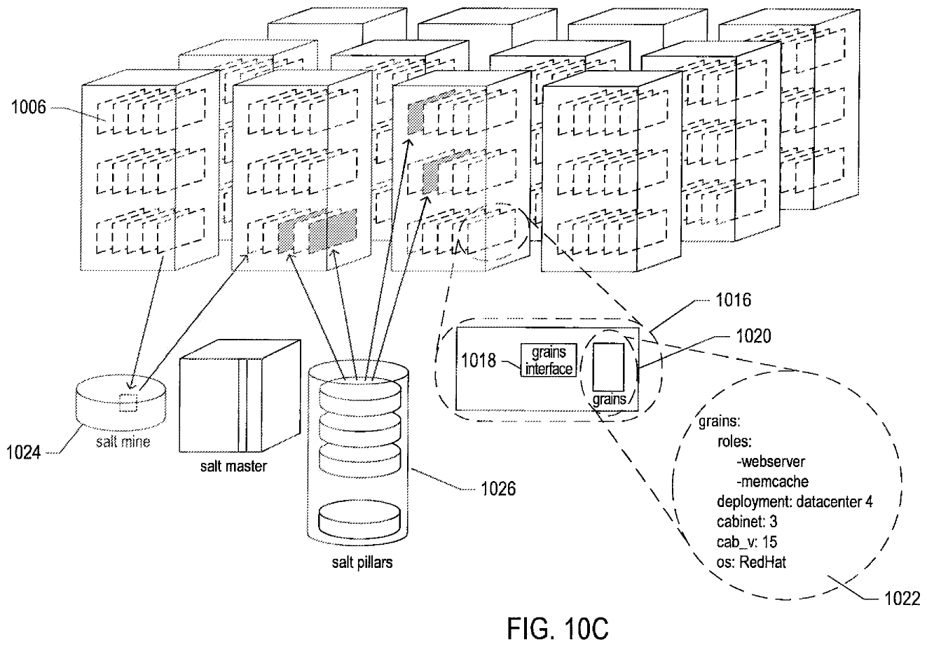

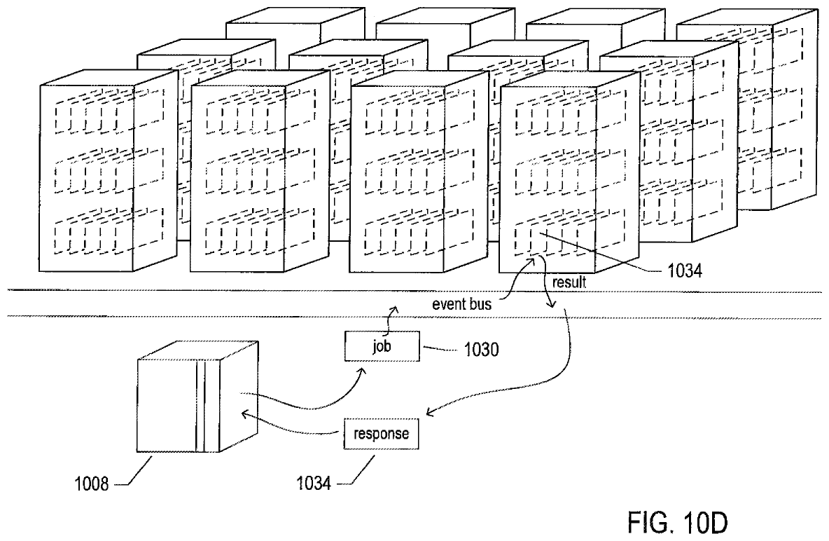

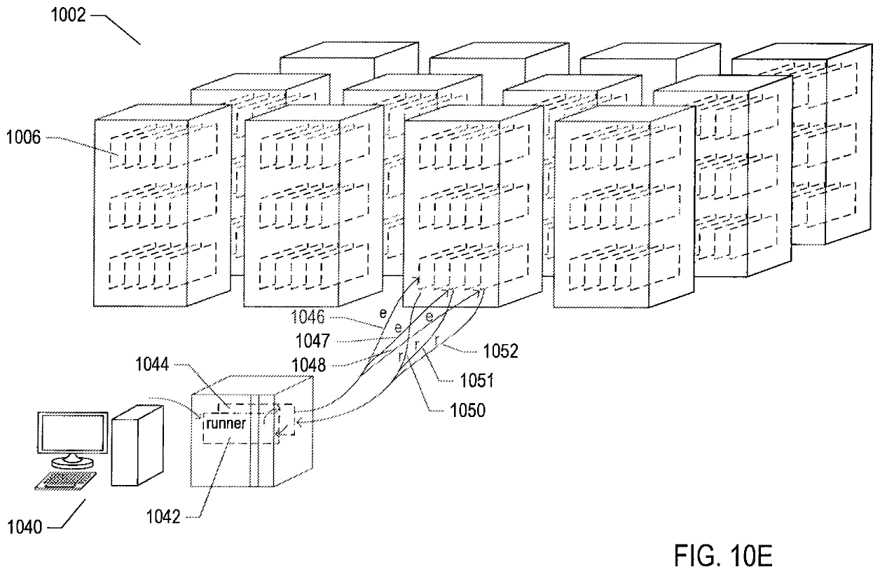

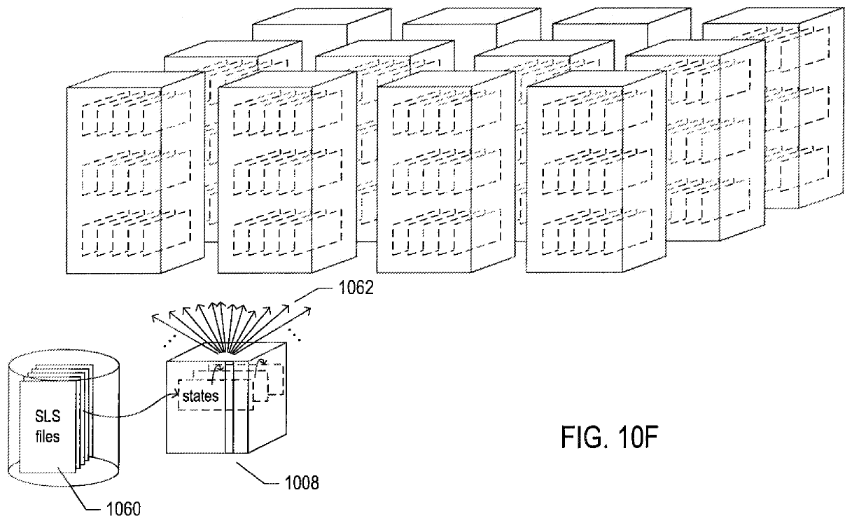

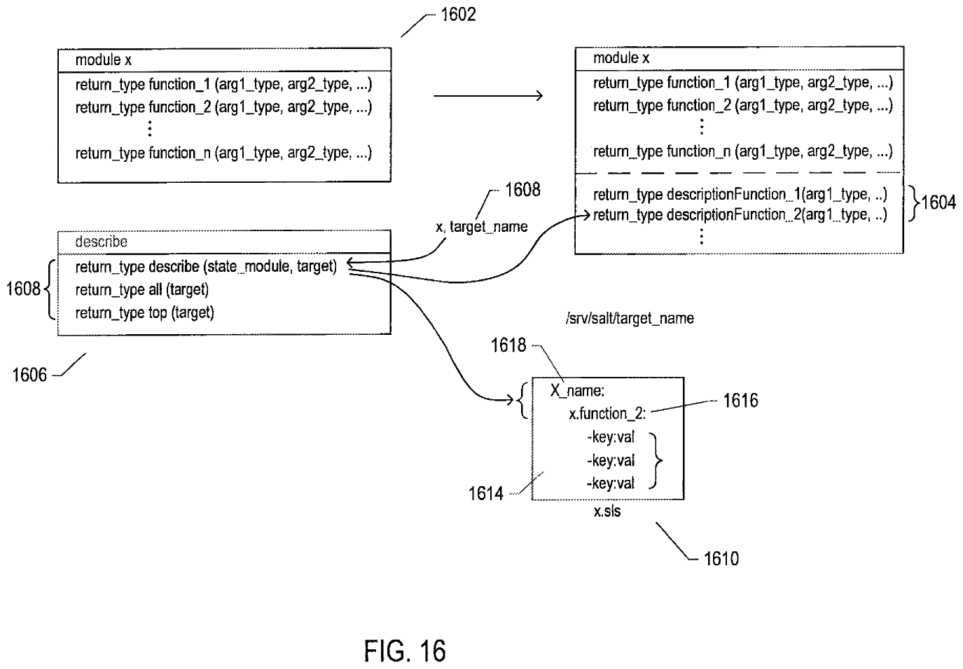

The current application is directed to a cloud-infrastructure-management service In a first subsection, below, a detailed description of computer hardware, complex computational systems, and virtualization is provided with reference to FIGS. 1-7. A second subsection provides an overview of YAML and JINJA, with reference to FIGS. 8A-9. A third subsection provides an overview of the Salt cloud-infrastructure-management service, with reference to FIGS. 10A-15. Finally, in a fifth subsection, the currently disclosed methods and systems are discussed with reference to FIGS. 16-18.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

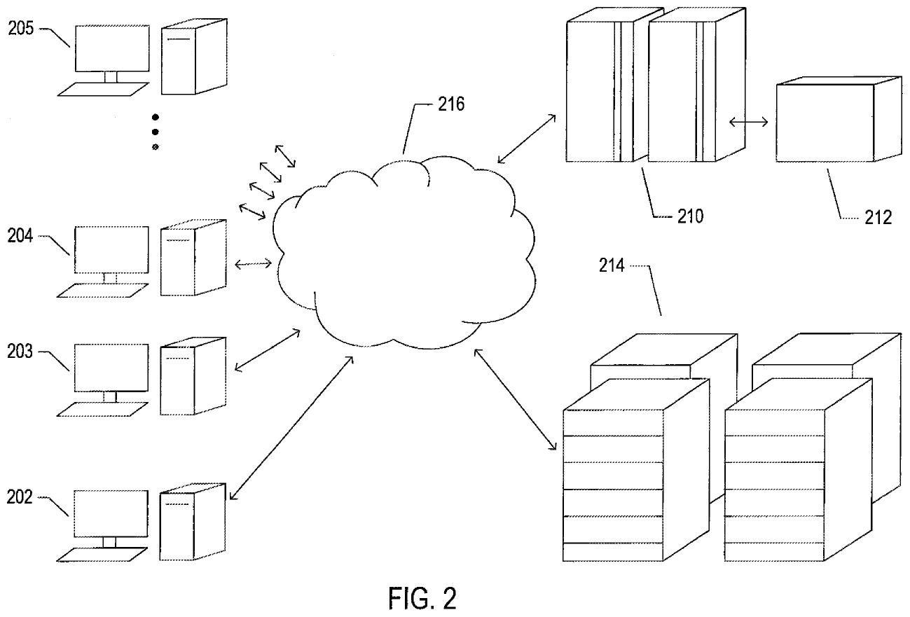

FIG. 2 illustrates an Internet-connected distributed computing system. As communications and networking technologies have evolved in capability and accessibility, and as the computational bandwidths data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

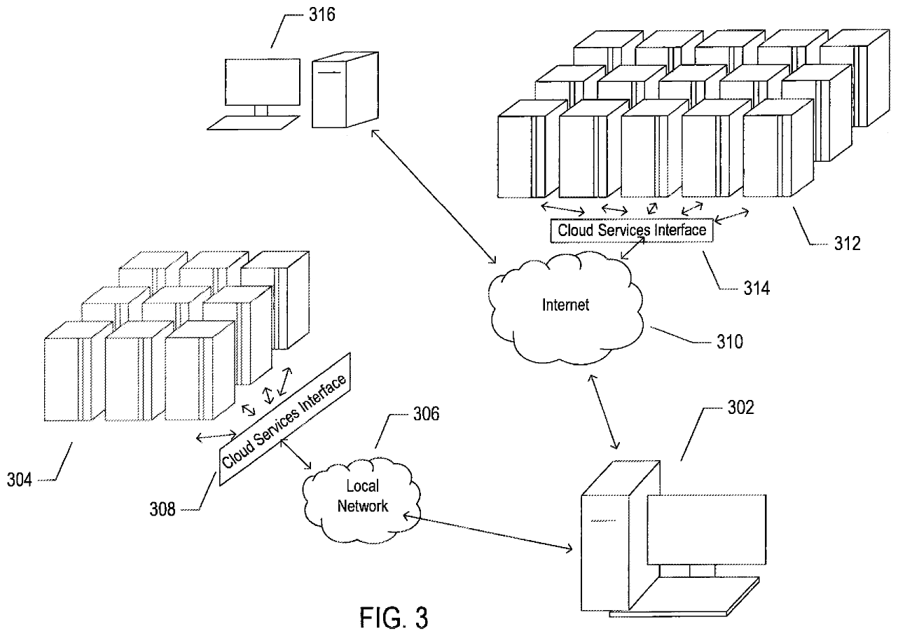

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

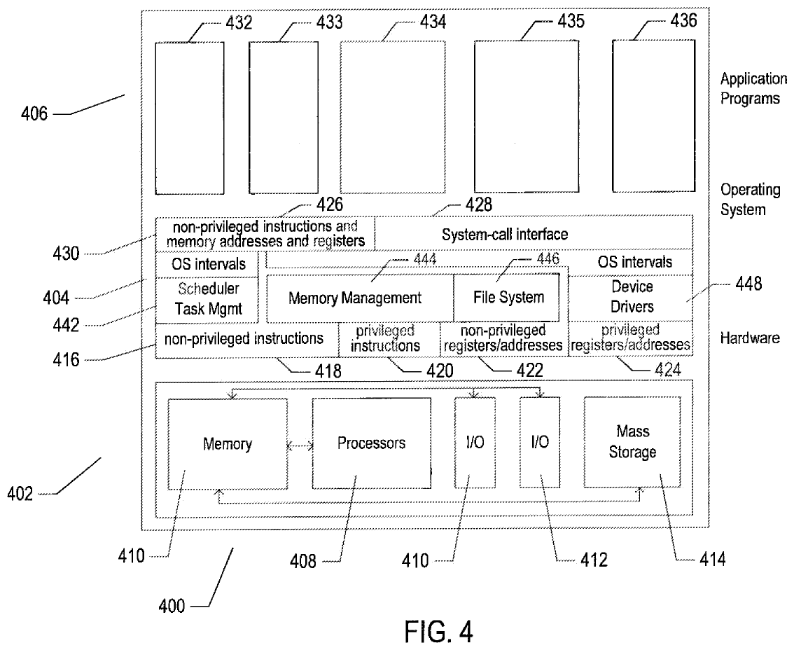

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

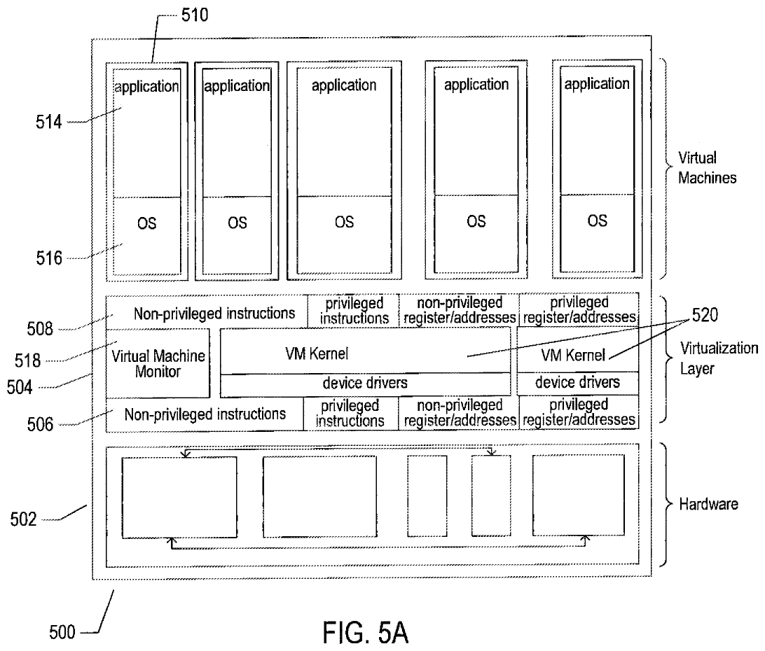

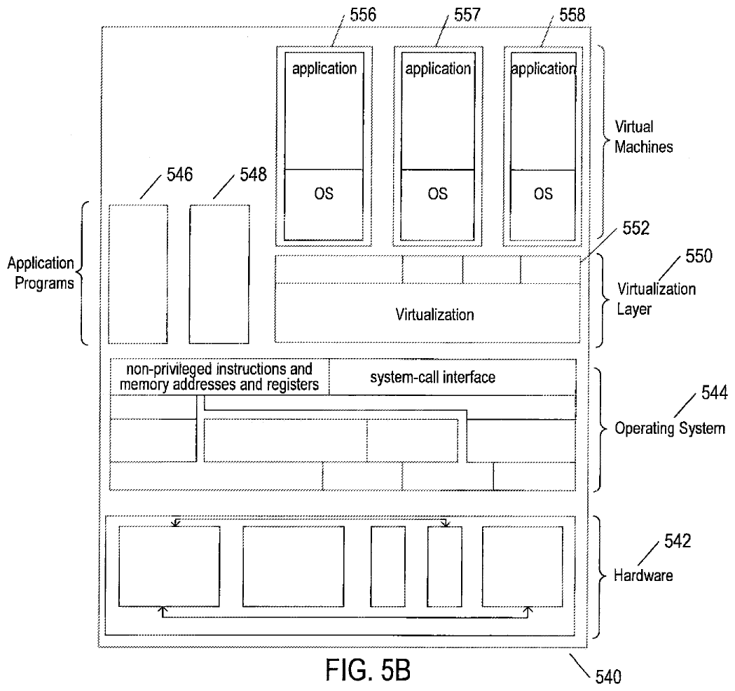

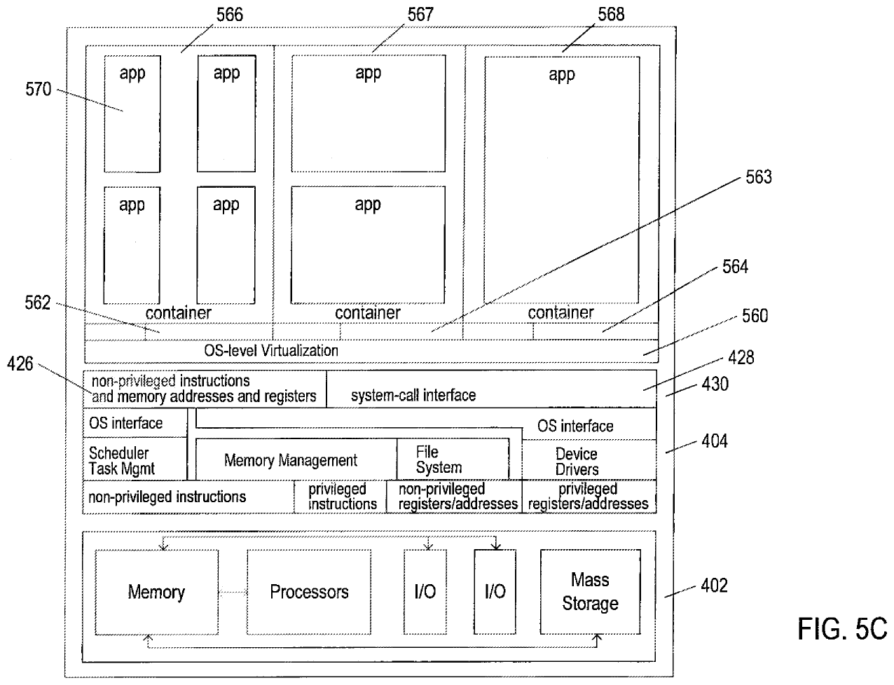

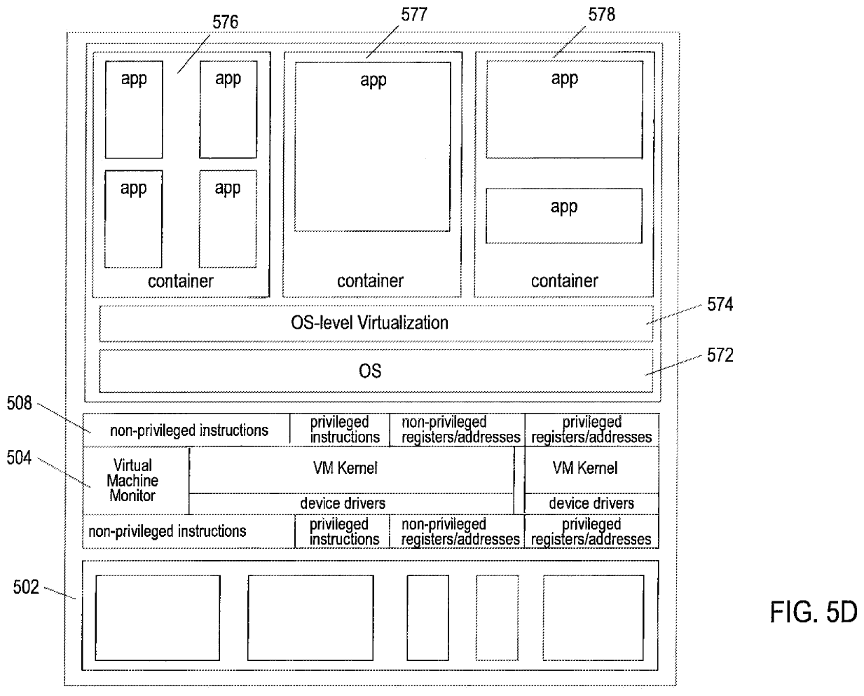

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however. OSL virtualization does not provide many desirable features of traditional virtualization. As mentioned above. OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

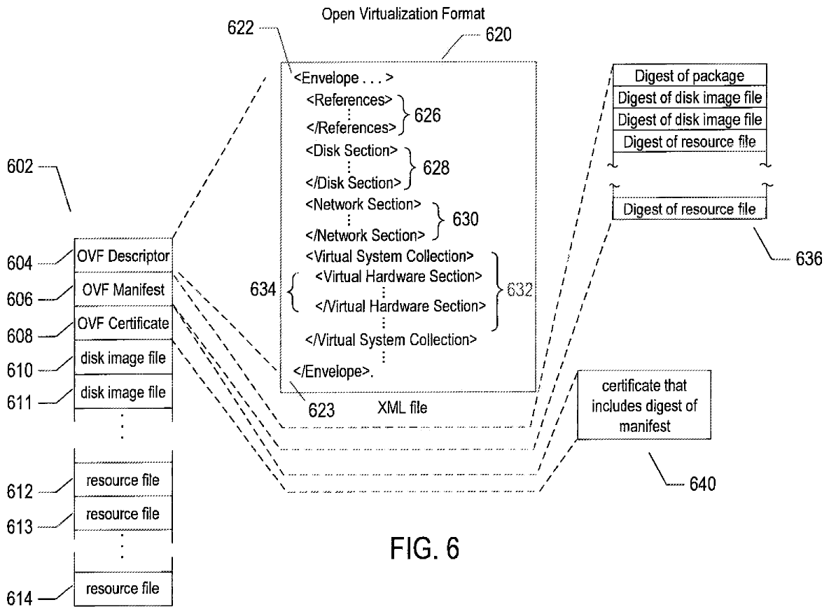

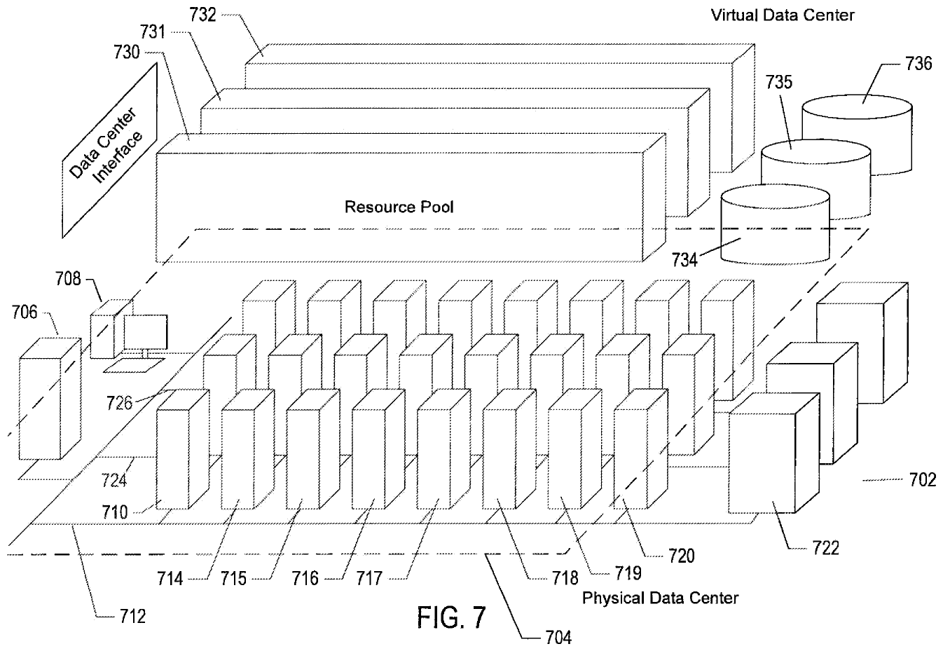

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### YAML/Jinja

FIGS. 8A-D illustrate the YAML Ain′t Markup Language (“YAML”) data serialization language. YAML provides for representing data in text files. Certain features of YAML are illustrated by the YAML document shown in FIGS. 8A-D. A YAML document begins with three hyphens (802 in FIG. 8A) and ends with three periods (803 in FIG. 8D.) Multiple YAML documents can be included in a single text file. Comments begin with a “#” symbol followed by a space, such as the comment 804. One of the fundamental constructs in YAML is a mapping of a scalar value to a scalar string, or name, such as the mapping 805 of the integer value 35 to the name “x” and the mapping 806 of the string value “Bill Johnson” to the name “Chairman.” YAML supports a variety of different types of scalars, as shown in the set of mappings 807, including: integers encoded as decimal integers 808, integers encoded as hexadecimal integers 809, and integers encoded as octal integers 810; floating-point numbers 811: Boolean values “Yes” 812 and “No” 813. “true” 814 and “false” 815, and “On” and “Off” 816; a value representing infinity 817; and a value representing “not a number” 818. On lines 819, two text lines are mapped to the name “text_stuff” with the symbol “|” used to indicate that newline characters in the text should be preserved. On lines 820, two text lines are mapped to the name “f_text_stuff,” with the symbol “>” indicating that newlines should be removed in order to fold the text into a single text block. Text can be unquoted or quoted, as indicated by the examples on lines 821. The “!!” operator can be used to explicitly assign types to values, as indicated on lines 822.

Turning to FIG. 8B, another fundamental data structure supported by YAML is the sequence or list. Several different representations of lists are supported. In a first representation of a list 823, the elements of the list are indicated by a preceding “-” and a space. In a second representation 824, the elements of the list are contained within brackets and separated by commas and spaces. As indicated on lines 825, a list can be mapped to a name. In the example of lines 825, a list of animals is mapped to the character string, or name, “animals.” Note that indentation is used, as in the Python programming language, to indicate hierarchical structure.

Lines 826 show a mapping of a more complex type of list to the name, or character string, “members.” In this example, the list is a list of blocks 827-829. Each block is preceded by a hyphen and a space. Each block contains a mapping of a character string to the character string “name” 830, a mapping of two text lines to the character string “address” 831, a mapping of an integer to the character string “age” 832, and a mapping of an alphanumerically encoded phone number to the character string “phone” 833. In the example of lines 834 at the bottom of FIG. 8B and lines 835 at the top of FIG. 8C, the mapping of the list of blocks to the character string “members” on lines 826 of FIG. 8B is modified to include two additional lines in each block of the list. The two additional lines are specified using the anchor symbol “&” on lines 836 at the bottom of FIG. 8B. The lines are included at the end of each block in the list using the reference prefix “<<: *” at the beginning of each of three lines referencing the anchor “chapter” 837-839. The modified list is equivalent to the list shown on lines 840 of FIG. 8C. Finally, on line 841 at the top of FIG. 8D, a more complex mapping that maps the list “[0, 1, 2]” to the list “[small, medium, large]” is shown. This mapping can alternatively be represented by the map sequence, or dictionary, shown on line 842. The example YAML document shown in FIG. 8A-D does not, of course, provide a comprehensive description of the YAML data-representation language, but is instead intended to show some of the main features and constructs of YAML that are used in SLS documents, discussed below.

FIG. 9 illustrates certain features provided by the Jinja template engine that are used, in addition to YAML, for representing infrastructure in SLS documents. Jinja employs several types of delimiters to encode Jinja constructs. These are shown on lines 902 of FIG. 9, with ellipses indicating that additional text is enclosed by the delimiters. A first type of delimiter 904 is used to encapsulate tests, control structures, and other programming-language-like constructs. A second type of delimiter 906 is used to encapsulate variables for output. A third type of delimiter 908 is used to enclose comments. Pipe symbols “|” can be used to indicate sequences of function calls. For example, the delimited string “name|striptags|title” 910 is equivalent to the character string 912, which represents calling a function “title” with an argument that represents a value returned by calling the function “striptags” with the argument “name.” Jinja supports if statements, as shown by the example on lines 914, and if-elseif-else statements, as shown by the example on lines 916. Jinja provides a set of comparison operators used in if and if-elseif-else statements. Finally, Jinja provides various types of control structures, such as for-loops, as indicated on lines 918. The for-loop control structure is accompanied with a number of Jinja loop variables 920 that can be used in conditional expressions within loops. FIG. 9 does not provide a comprehensive list of examples of Jinja features and constructs, but is instead intended simply to show some of the main types of Jinja constructs that, in combination with YAML constructs and features, are used in SLS documents, described below.

### Salt System

FIGS. 10A-F illustrate the Salt cloud-infrastructure-management service. FIG. 10A shows an example environment managed by a Salt system. A distributed computer system 1002 is illustrated as containing multiple cabinets, such as cabinet 1004, each containing multiple server circuit boards, such as server circuit board 1006, that each implements a server component of the distributed computer system. Each server incorporated into the Salt system runs a Salt-minion component of the Salt cloud-infrastructure-management service. The Salt minions execute functions within execution modules on behalf of a Salt-master cloud-infrastructure-management service running on the Salt master 1008. The Salt master may include one or more servers within the distributed computer system 1002 or may be implemented on a computer system external to the distributed computer system.

FIG. 10B illustrates execution, by a targeted subset of the minions, of one or more functions of an execution module, as directed by the Salt-master service. The Salt-master service maintains a set of execution modules, each execution module comprising one or more functions generally associated with the configuration and management of a particular type of computational resource. Each Salt minion generally downloads and maintains those execution modules relevant to the configuration and management of the Salt minion. The Salt-master service issues a job comprising one or more function-execution requests and associated with targeting information that allows the individual Salt minions to determine whether or not they should locally execute the job. In FIG. 10B, the targeted Salt minions are shaded, such as salt minion 1010. The targeted Salt minions locally execute the one or more functions associated with the job and return response information to the Salt master. In FIG. 10B, a pair of arrows labeled e and r, such as the pair of arrows 1012, represent the request for execution by the Salt master and response by the targeted Salt minions. Remote execution of functions within execution modules by Salt minions on behalf of the Salt master provides the basis for cloud-infrastructure configuration and management by the Salt system.

FIG. 10C illustrates data-storage and data-collection by the Salt system. As shown in inset 1016, each Salt minion includes a grains interface 1018 and stored information referred to as “grains” 1020. The grains are local information collected and stored by a Salt minion with regard to characteristics and parameters of the Salt minion relevant to cloud-infrastructure management by the Salt master. The grains can be thought of as a set of key/attribute pairs, such as the key/attribute pairs 1022 expressed in YAML. The grains interface 1018 supports export of grains by a Salt minion to external entities, including other Salt minions and the Salt master. The Salt master maintains a Salt mine 1024 which contains a constantly updated collection of grains for the Salt minions in the distributed computer system. The Salt mine is continuously updated by the Salt minions and can be accessed by a Salt minion to efficiently access grains provided by other Salt minions. In addition, the Salt master maintains a collection of salt pillars 1026. The collection of salt pillars is a database of stored information, portions of which can be selectively targeted for export to particular sets of Salt minions. The stored information includes execution modules and the Salt state tree, discussed below.

FIG. 10D illustrates communications between the Salt master and Salt minions. As mentioned above, the Salt master 1008 issues jobs, such as job 1030, for execution by a targeted set of Salt millions. The jobs are issued to an event bus 1032. Salt minions monitor the event bus and detect jobs issued by the Salt master. A Salt minion, such as salt minion 1034, determines, from targeting information associated with the job, whether or not the Salt minion should execute one or more functions specified in the job. The Salt minion's decision may be based, wholly or in part, on comparing specified target characteristics with local Salt-minion characteristics stored as grains. When a Salt minion determines that the Salt minion is included in the targeted set of Salt minions for execution of the job, the Salt minion locally executes one or more functions of one or more execution modules specified in the job and then posts a response to the event bus 1032. The Salt master detects the posted response 1034 and processes the response, such as storing information contained in the response as part of configuration and maintenance information stored by the Salt master.

FIG. 10E illustrates execution of a runner function or routine. Execution of a runner function or routine is initiated by a user or user application 1040. The runner function or routine 1042 is executed by the Salt master. In general, the runner function or routine calls various execution-module functions 1044 that are sent to, and executed by, one or more Salt minions via the event bus, as indicated by the outgoing arrows 1046-1048 and incoming arrows 1050-1052. Runner functions or routines can be implemented for rapid incorporation into the Salt system, unlike implementation of Salt-master configuration-and-management functionality and implementation and distribution of execution modules, which occurs at specific intervals.

FIG. 10F illustrates state-module-based cloud-infrastructure configuration and management. The Salt system is designed to configure and manage cloud infrastructure based on configuration-and-management information encoded in a set of structured layered state (“SLS”) data files 1060. State-module-based cloud-infrastructure configuration and management is an example of infrastructure-as-code (“IaC”) cloud-infrastructure configuration and management. SLS data files are discussed further, below. They are, in general, high-level YAML/Jinga-encoded configuration-and-management statements that specify the desired and continuously enforced configuration of cloud infrastructure managed by the Salt system.

Unlike remote execution of execution-modules functions by Salt minions, the enforcement of states by state-module-based cloud-infrastructure configuration and management is idempotent. An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation. The Salt master can repeatedly apply SLS files containing state definitions to the Salt minions within the distributed computer system to enforce the desired configuration encoded in the SLS state files since application of the state-module functions specified in state definitions contained in SLS state files is an idempotent operation.

As illustrated in FIG. 10F, the Salt master applies states contained in the stored SLS state files 1060 to the Salt minions within the distributed computer system, as indicated by the multiple arrows 1062 emanating from the salt master 1008. The state-application jobs issued by the Salt master to the event bus are detected by the Salt minions, which then access the SLS state files within the Salt state tree to determine a relevant set of states to enforce and then locally execute execution-module functions to execute state-module functions specified in the state definitions within the SLS state files, as needed, to ensure that the local configuration of the Salt minion corresponds to the configuration specified in the SLS state files. Unlike in previous technologies, that require extensive development of programs and scripts that are executed to carry out configuration and management, the configurations for cloud infrastructure are specified, for an IaC configuration-and-management system, as a set of high-level specifications encoded in YAML or another data-specification language.

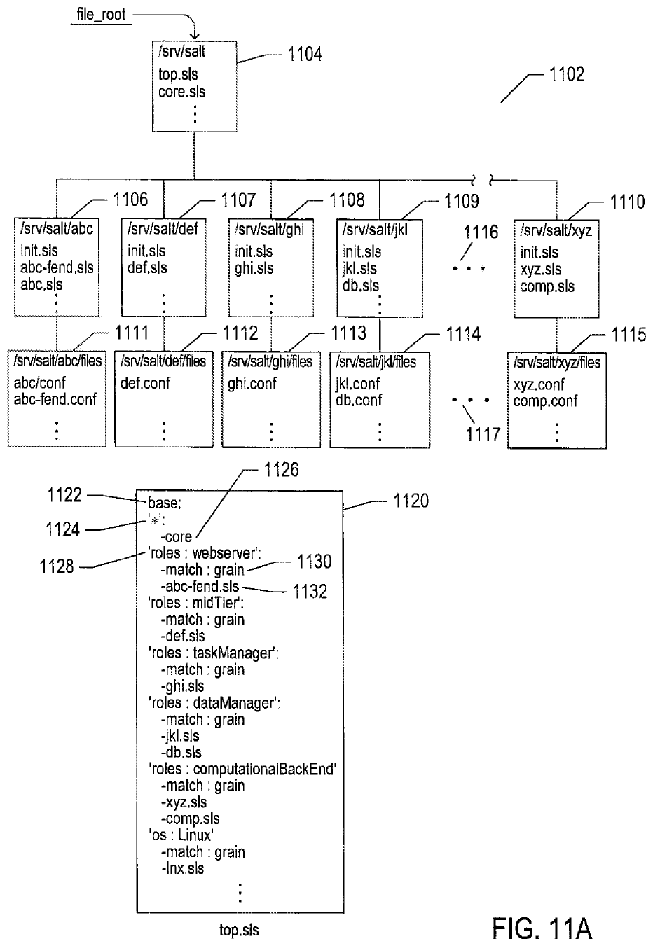

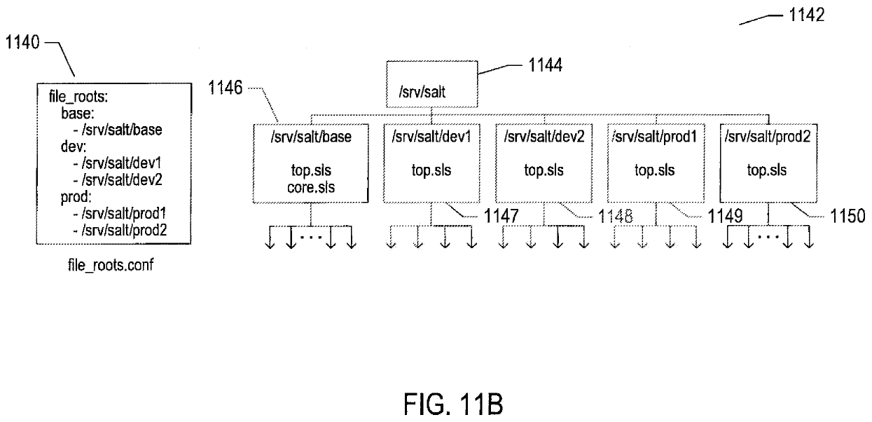

FIGS. 11A-B illustrate the Salt state tree. The Salt state tree 1102 is a hierarchical file-directory structure that includes a root directory 1104 and underlying subdirectories 1106-1115. Ellipses 1116-1117 indicate that there may be additional subdirectories. The Salt state tree may be significantly more complex than the simple example shown in FIG. 11A. Each of the subdirectories 1106-1110 contains SLS state files associated with a particular state module, with the state modules generally corresponding to different types of computational resources that are configured and managed by the Salt system. In the example shown in FIG. 11A, the subdirectories have arbitrary three-character names, such as the name “abc” for subdirectory 1106. These names represent the names of different state modules. The subdirectories may each include an init.sls file and one or more additional SLS data files that contain the state definitions for the computational resources of the type of computational resource associated with the subdirectory. The second-level subdirectories 1111-1115 store various configuration text files that may be accessed during application of states. The top.sls file in the root directory 1104 matches relevant Salt states to particular Salt minions. A portion of an example top.sls file 1120 is shown below the representation of an example Salt state tree 1102 in FIG. 11A. The initial statement 1122 in the example top.sls file indicates that the following key/attribute-value pairs correspond to the base Salt environment. The key in each key/attribute-value pair is a match value and the attribute value indicates the SLS state file or files relevant to a Salt minion with a characteristic or parameter that matches the match value. The key “*” 1124 matches all Salt minions. In the example shown in FIG. 11A, all Salt minions should therefore apply the core.sls file in the root directory 1104, as indicated by the single list member “core” 1126 in the list representing the attribute value for key 1124. The key “roles:webserver” 1128 specifies a particular role for a particular Salt minion, the initial list member “match: grain” 1130 indicates that the role specified in a grain locally stored by the Salt minion should be matched against the key, and the list member “abc-fend.sls” 1132 indicates that a Salt minion implementing the role “webserver” should apply the SLS data file “abc-fend.sls.”

As shown in FIG. 11B, multiple different Salt environments may be defined. A configuration file file_routes.conf 1140 contains indications of the root directories for the Salt state trees for each defined Salt environment. The Salt state tree 1142 includes an overall root directory 1144 and then subdirectories 1146-1150 that represent environment-specific root directories. The subdirectories under each of the environment-specific root directories would then have hierarchical structures such as those shown below the root directory 1104 in FIG. 11A.

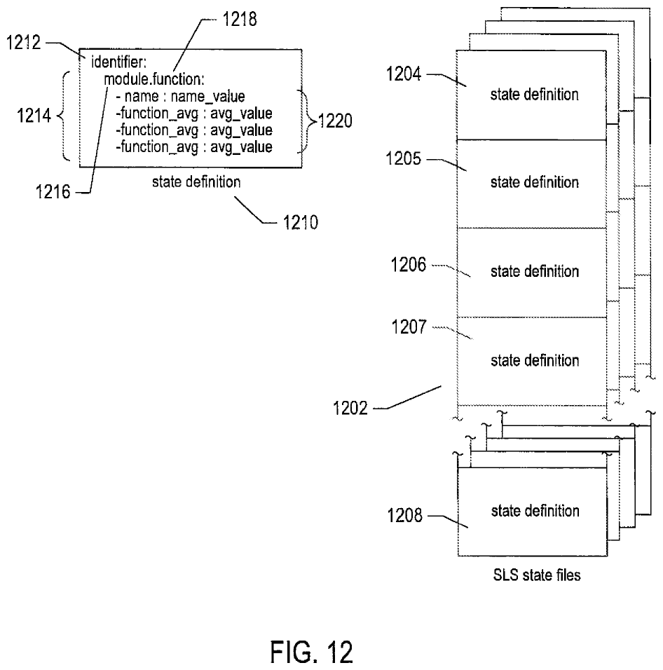

FIG. 12 illustrates the contents of SLS state files. Each SLS state file, such as SLS state file 1202, contains one or more state definitions 1204-1208. A state definition 1210 includes: (1) a state identifier 1212; and (2) one or more state-module-function calls 1214. The example state-module-function call in state definition 1210 includes a two-part function name that includes the name of the state module 1216 and the name of the function within the state module 1218. The two-part function name is followed by a set of one or more key/attribute-value pairs 1220. The key/attribute-value pairs generally contain argument values for the function call but may also contain a function name and other information. The state-module functions generally call execution-module functions to carry out state enforcement. As discussed above, the state-module functions are idempotent.

FIG. 13 shows init.sls and server.sls files for a secure-shell state module. The init.sls file specifies installation of an openssh client package 1302 and creation of a ssh_config file 1304 once the openssh client is installed 1306. The server.sls file specifies installation of an openssh server package 1308 and verification that the server service is launched following installation of the client and server packages and creation of several files 1310.

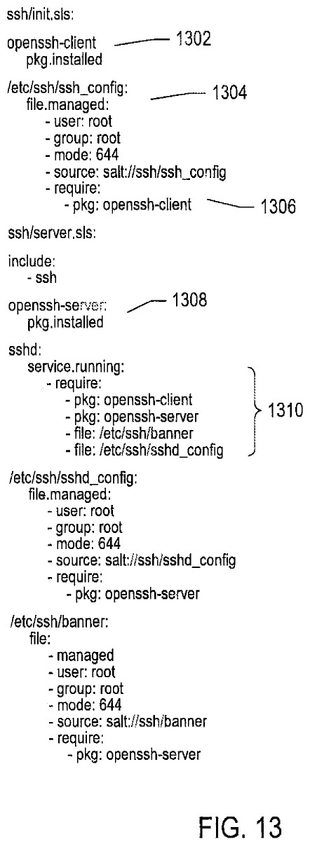

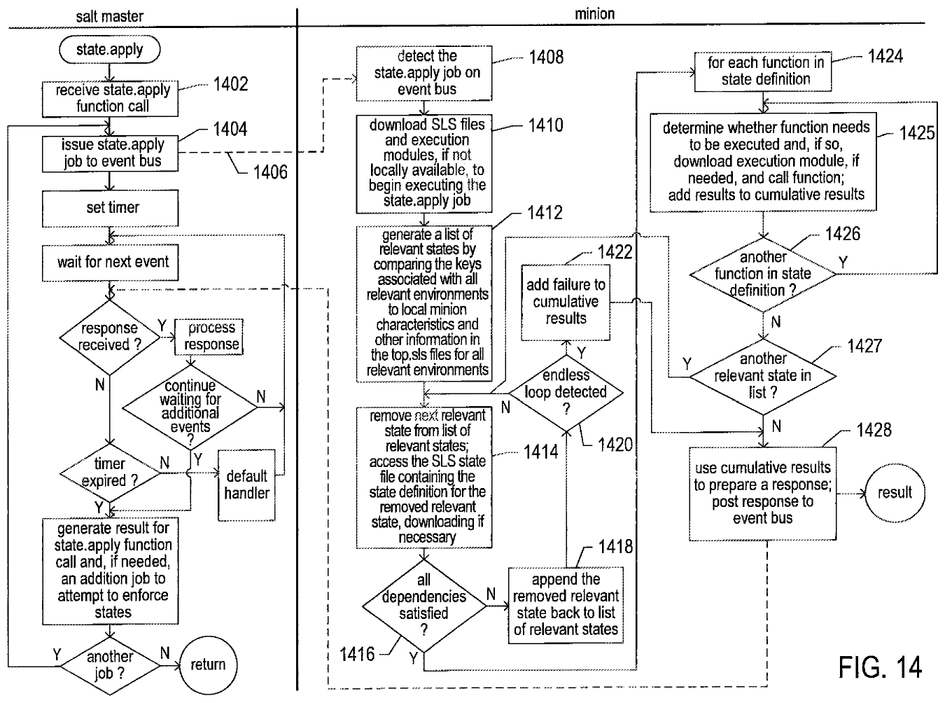

FIG. 14 illustrates a state.apply operation carried out by a Salt master. In step 1402, the Salt master receives a state.apply function call. In step 1404, the Salt master issues a state.apply job to the event bus. Dashed arrow 1406 represents issuance of the job to the event bus. In step 1408, a Salt minion detects the state.apply job on the event bus. In step 1410, the Salt minion downloads any SLS state files and execution modules that may be needed, but that are not currently locally available to the Salt minion, and begins executing the state.apply job. In step 1412, the Salt minion uses the top.sls file in the root directory of the Salt state tree to generate a list of relevant states to enforce by comparing parameters and characteristics of the Salt minion to keys in the top.sls file, as discussed above with reference to FIG. 11A. In step 1414, the Salt minion removes the next relevant state from the list of relevant states prepared in step 1412 and accesses the SLS state file that contains a definition for the next relevant state, downloading the SLS state file if necessary. When all the dependencies for enforcing the state are not satisfied, such as dependencies specified in requisite statements, as determined in step 1416, the state is appended back onto the list of relevant states for later enforcement, in step 1418. In the case that an endless loop or other anomalous behaviors are detected to result from the inability to satisfy dependencies, in step 1420, a failure indication is added to cumulative results for execution of the state.apply job, in step 1422, and control flows to step 1428, discussed below. Otherwise, control flows back to step 1414 for processing of a next relevant state. When all dependencies for a relevant state have been satisfied, as determined in step 1416, control flows to a for-loop comprising steps 1424-1426, in which each state-module function contained in the state definition is executed when necessary to enforce the state. Following completion of the for-loop comprising steps 1424-1426, when there is another relevant state to enforce, as determined in step 1427, control flows back to step 1414. Otherwise, in step 1428, the Salt minion prepares a response using the cumulative results compiled during execution of the state.apply job and the responses posted to the event bus.

The Salt master may enforce states in response to receiving specific directives and function-execution requests and may also enforce states at predefined points in time to ensure that the configuration of cloud infrastructure managed by the Salt master corresponds to the specified configuration.

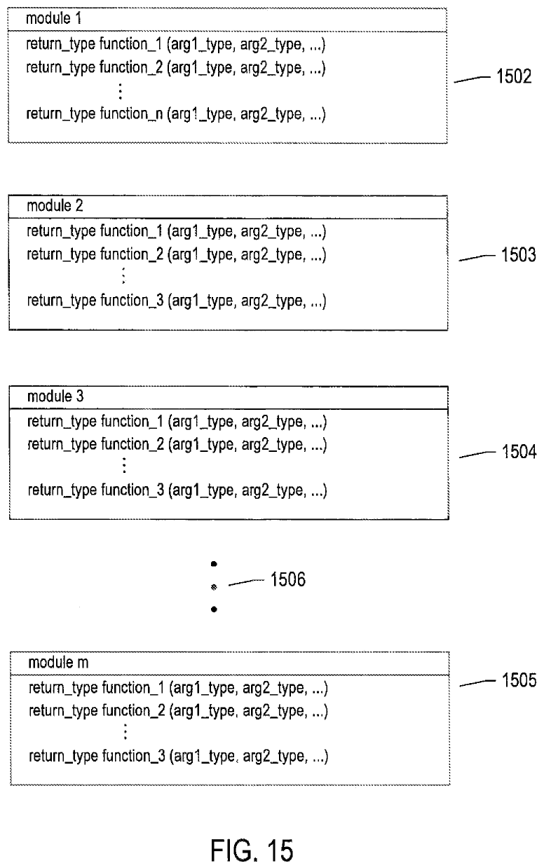

FIG. 15 illustrates a basis for state enforcement and IaC cloud-infrastructure configuration and management. IaC cloud-infrastructure configuration and management by the Salt service depends primarily on a set of state modules 1502-1505 that together implement state enforcement for all of the various different states defined for the various different types of computational resources. Note that ellipsis 1506 indicates that there may be many additional state modules. Each state module comprises a set of one or more state-module functions that are each implemented by logic and calls to execution-module functions that are locally executed by Salt minions.

### Currently Disclosed Methods and Systems

IaC configuration and management has many advantages over earlier types of configuration-and-management systems and services. It is generally much easier and much more efficient to specify cloud-infrastructure configurations and to manage cloud infrastructure using high-level encodings, such as SLS state files, then to develop and maintain complex application programs and scripts to automate configuration-and-management tasks. However, there is, nonetheless, a relatively steep learning curve involved in launching an IaC configuration management service or transitioning configuration and management from earlier types of configuration-and-management systems and services to an IaC configuration management service, such as Salt. Human users need to learn to construct SLS state files and need to understand the organization and construction of the Salt state tree. While various different types of data-specification languages can be used, YAML encoding enhanced with Jinja constructs are commonly used for configuration encodings contained in SLS state files. Because the Salt service is implemented using Python, and because Python syntax inspires the encoding of SLS state files, a user unfamiliar with YAML, Jinja, and Python may find the learning curve to be quite steep and that adopting or transitioning to Salt-service configuration management is associated with significant effort and overheads. These overheads and learning curves motivated the currently disclosed improvements to the Salt service. The overheads and learning curves can be vastly decreased by providing functionality in the Salt service to allow users to direct the Salt service to generate SLS state files, top.sls files, and Salt state trees, or portions of Salt state trees, by discovering the characteristics and parameters of Salt minions and using the discovered information to generate SLS state files, top.sls files, and Salt state trees, or portions of Salt state trees, that reflect the current states of the Salt minions. The generated files can be used for trial application to cloud infrastructure and can serve as templates that can be modified by users to specify additional allocation and deployment of computational resources as well as additional or different configuration and management directives.

FIG. 16 illustrates additions to the Salt service that provide for the currently disclosed improvements to the Salt service. As discussed above with reference to FIG. 15, a basis for IaC configuration-and-management functionality is the set of Salt state modules, such as state module 1602. One improvement needed to provide the currently disclosed improvements to the Salt service is to add one or more information-returning functions 1604 to each state module. These functions return the key/argument-value pairs for specified state-module function arguments in SLS state files and any other information needed for constructing SLS state files that represent the current state of a Salt minion. A second improvement needed to provide the currently disclosed improvements to the Salt service is to add a describe state module 1606 with a set of describe-state-module functions 1608. The describe-state-module functions include: (1) describe, which generates an SLS state file for a specified state module and target minion; (2) all, which generates SLS state files for all state modules relevant to a specified target minion; and (3) top, which generates a top.sls file for the SLS state files generated by the describe and all functions for a particular target minion. For example, the describe function receives an indication of a state module and a target minion 1608, creates an example SLS state file for the state module and target minion 1610 in a directory in the Salt state tree for the target minion 1612, and calls an information-returning function to obtain the key/attribute-value pairs that specify the arguments 1614 for the state-module function 1616 call to enforce the state 1618 for the specified state module.

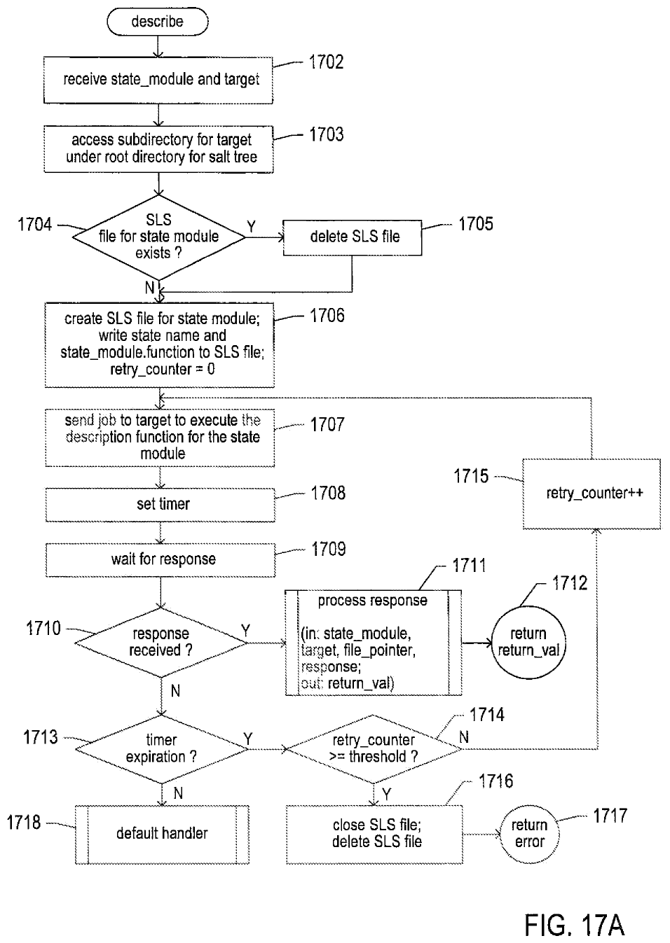

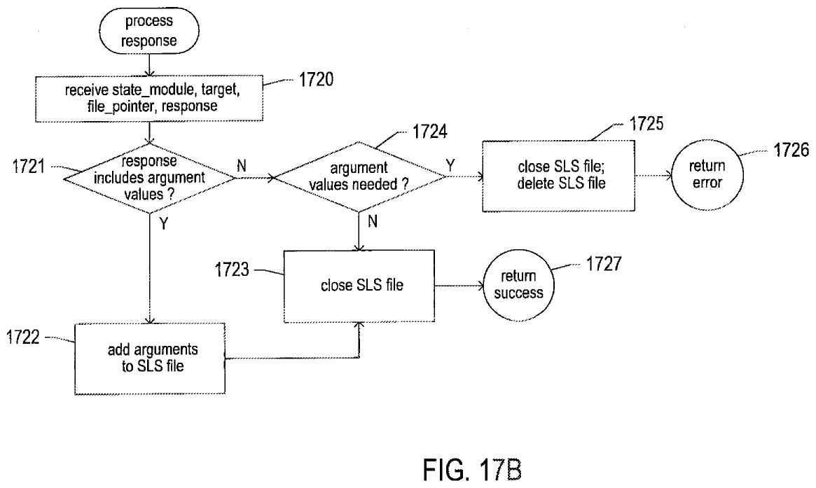

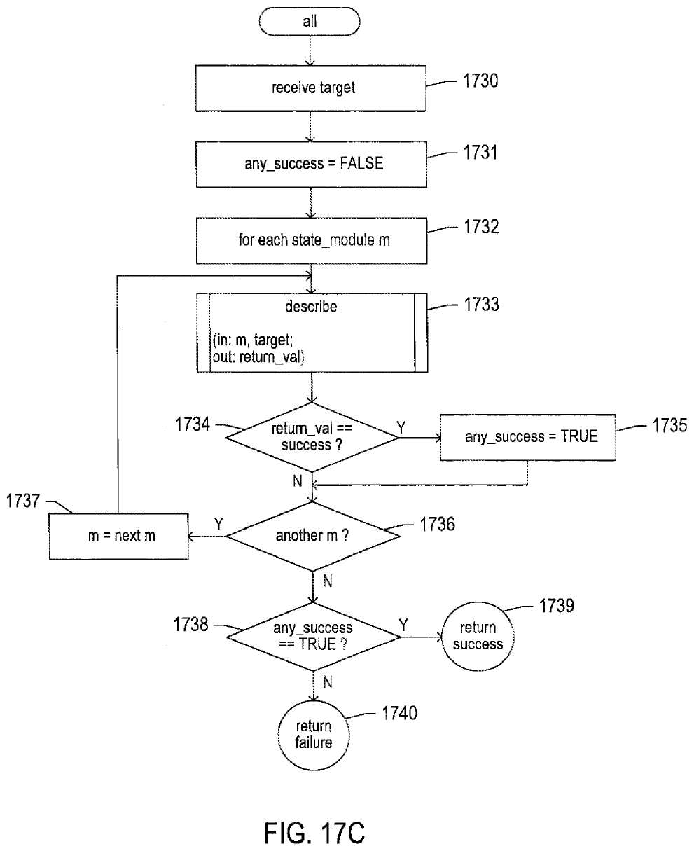

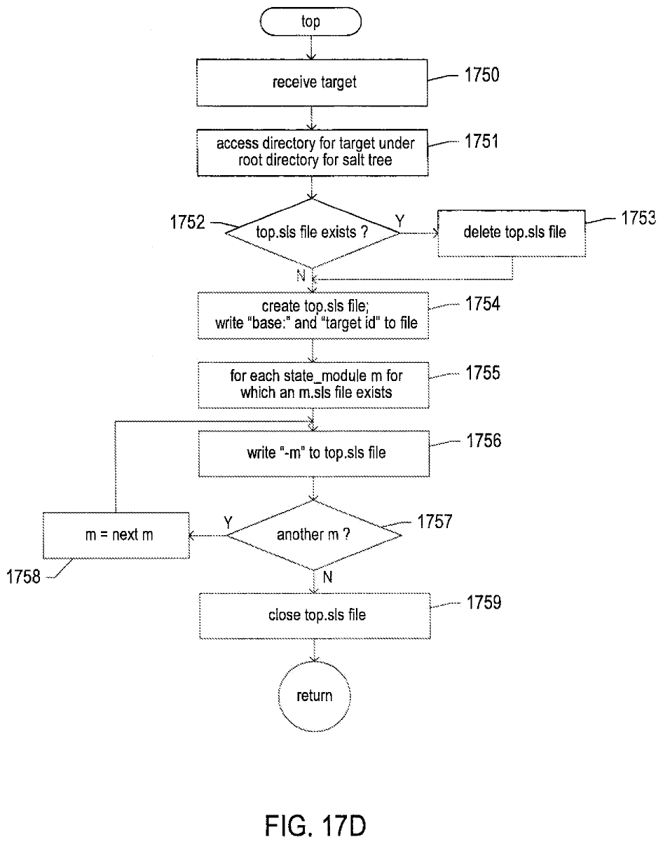

FIGS. 17A-D provide control-flow diagrams that represent implementations of the describe-state-module functions in the additional describe state module discussed above with reference to FIG. 16. FIG. 17A provides a control-flow diagram for the describe-state-module function describe. In step 1702, indications of a state module and target minion are received. In step 1703, the subdirectory for the target minion is accessed, including creating the subdirectory if it does not currently exist. When the subdirectory already includes an SLS state file, as determined in step 1704, the SLS state file is deleted, in step 1705. In step 1706, an SLS state file for the indicated state module is created, a state name and state-module function are written to the SLS state file, and a local variable retry_counter is set to 0. In step 1707, a job is directed to the target minion to execute the information-returning function for the specified state module. In step 1708, a timer is set. Then, in step 1709, the describe function waits for a response from the target minion. When a response is received, as determined in step 1710, a routine “process response” is called in step 1711, after which the value returned by the function “process response” is returned as the return value for the describe function, in step 1712. Otherwise, if a timer-expiration event is detected, as determined in step 1713, and when the value stored in local variable retry_counter is less than a threshold value, as determined in step 1714, local variable retry_counter is incremented, in step 1715, and control returns to step 1707 for another attempt at executing the job. When the value stored in the variable retry_counter is greater than or equal to the threshold value, as determined in step 1714, the SLS state file created in step 1706 is closed and deleted, in step 1716, followed by return of an error indication in step 1770. For any other event that occurs following the wait step 1709, a default handler is called in step 1718.

FIG. 17B provides a control-flow diagram for the routine “process response,” called in step 1711 of FIG. 17A. In step 1720, the routine “process response” receives an indication of the state module, an indication of the target minion, a file pointer for the SLS state file created in step 1706 of FIG. 17A, and the response from the target minion. When the response includes one or more argument values, as determined in step 1721, the arguments are added to the SLS state file, in step 1722, after which control flows to step 1723. However, when the response does not include argument values, as determined in step 1721, and when argument values are needed for the SLS state file, as determined in step 1724, the SLS state file is closed and deleted, in step 1725, and an error return value is returned in step 1726. When argument values are not needed, as determined in step 1724, control flows to step 1723 in which the SLS state file is closed and a success indication is returned in step 1727.

FIG. 17C provides a control-flow diagram for the describe-state-module function “all.” In step 1730, the function “all” receives an indication of a target minion. In step 1731, the function “all” sets local variable any_success to FALSE. In the for-loop of steps 1732-1737, the function “all” calls the function “describe” for each state module m. When the function “describe” returns a success indication, as determined in step 1734, the local variable any_success is set to TRUE, in step 1735. Following completion of the for-loop of steps 1732-1737, when the value stored in local variable any_success is TRUE, as determined in step 1738, a success indication is returned in step 1739. Otherwise, a failure indication is returned in step 1740.

FIG. 17D provides a control-flow diagram for the describe-state-module function “top.” In step 1750, the function “top” receives an indication of a target minion. In step 1751, the function “top” accesses the subdirectory for the target minion under the root directory for the Salt state tree. When a file top.sls is present in the subdirectory, as determined in step 1752, the top.sls file is deleted, in step 1753. In step 1754, the routine “top” creates a new top.sls file and writes a base environment statement and a target-minion identifier to the file. Then, in the for-loop of steps 1755-1758, the function “top” adds an SLS-state-file indication for each SLS state file in the target-minion subdirectory. In step 1759, the routine “top” closes the top.sls file.

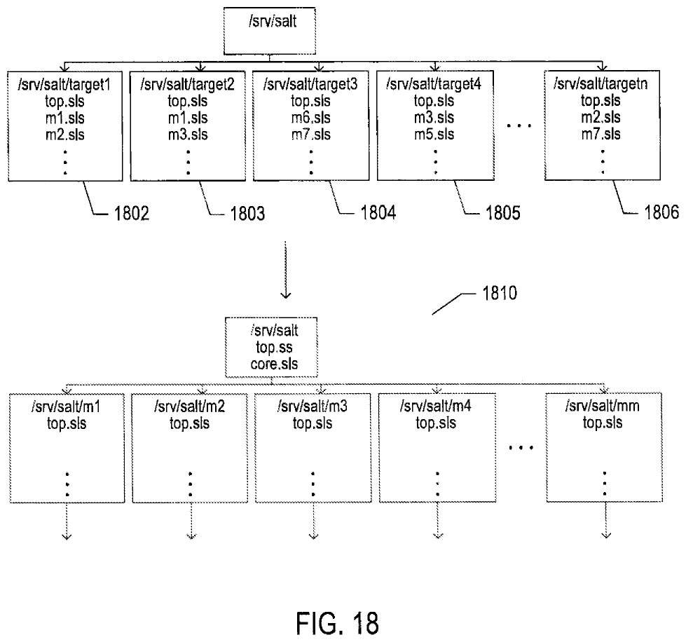

FIG. 18 illustrates an additional operation that may be carried out by the Salt service with respect to the SLS state files and top.sls files created for target minions via the describe-state-module functions discussed above. Execution of the describe-state-module functions produces a set of subdirectories 1802-1806 for the various target minions specified in calls to the describe-state-module functions. A user can direct the Salt-service to individually apply the SLS state files for a particular target minion and a user can use the SLS state files as templates for developing a full management-and-configuration specification. However, it may be desirable for these target-minion-specific SLS state files to be coalesced and turned into a generalized Salt state tree 1810 similar to the Salt state trees discussed with reference to FIGS. 11A-B.

There are many possible additional uses for the describe-state-module functions. As one example, they can be used to store the current states of Salt minions prior to configuration changes to provide a roll-back functionality. Furthermore, they can be used in tandem with an operation that initially configures Salt minions within a distributed computer system in order to automatically generate a Salt state tree and SLS state files that represent the initial configurations of the Salt minions.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters.

1. An infrastructure-as-code cloud-infrastructure-management service that manages cloud infrastructure provided by a distributed cloud-computing system, the infrastructure-as-code cloud-infrastructure-management service comprising:
a master, implemented in one or more computer systems, each containing one or more processors, one or more memories, and one or more data-storage devices;
multiple minions, each minion
running within a server within the distributed cloud-computing system,
executing functions within execution modules in response to jobs issued by the master,
returning response information resulting from function executions to the master, and
including a grains interface and stored information referred to as “grains;”
a mine, maintained by the master, which contains a constantly updated collection of grains provided by the minions;
a collection of pillars, maintained by the master, that together comprise a database of stored information, including execution modules execution modules and one or more state trees, portions of which can be selectively targeted for export to particular sets of minions; and
a describe state module for generating infrastructure-as-code configuration-specification files.

2. The infrastructure-as-code cloud-infrastructure-management service of claim 1 wherein each execution module comprises one or more functions generally associated with the configuration and management of a particular type of computational resource.

3. The infrastructure-as-code cloud-infrastructure-management service of claim 1 wherein jobs issued by the master include one or more function-execution requests and are associated with targeting information that allows each minion to determine whether or not they should locally execute the job.

4. The infrastructure-as-code cloud-infrastructure-management service of claim 1 wherein each grain is local information encoded in a set of key/attribute pairs collected and stored by a minion with regard to characteristics and parameters of the minion relevant to cloud-infrastructure management by the master.

5. The infrastructure-as-code cloud-infrastructure-management service of claim 1 wherein the master executes runner functions or routines upon request from a user or user application, the runner functions or routines calling execution-module functions that are sent, via an event bus, to, and executed by, one or more minions.

6. The infrastructure-as-code cloud-infrastructure-management service of claim 1 wherein cloud infrastructure within the distributed cloud-computing system is configured and managed based on configuration-and-management information encoded in a set of configuration-and-management data files.

7. The infrastructure-as-code cloud-infrastructure-management service of claim 6 wherein the master applies states, contained in stored configuration-and-management data files, to minions by issuing state-application jobs to an event bus, the jobs detected by the minions, a minion using targeting information included in the job to decide whether to execute the job and, when the minion decided to execute the job, the minion accesses the configuration-and-management data files within a state tree to determine a relevant set of states to enforce and then locally executes execution-module functions to execute state-module functions specified in state definitions within the configuration-and-management data files, as needed, to ensure that a local configuration of the minion corresponds to a configuration specified in the configuration-and-management data files.

8. The infrastructure-as-code cloud-infrastructure-management service of claim 7 wherein a state tree is a hierarchical file-directory structure that includes a root directory and underlying subdirectories, each subdirectory containing configuration-and-management data files associated with a particular state module, with the state modules generally corresponding to different types of computational resources that are configured and managed by the master.

9. The infrastructure-as-code cloud-infrastructure-management service of claim 2 wherein a configuration-and-management data file contains one or more state definitions, each state definition including:
a state identifier; and
one or more state-module-function calls.

10. The infrastructure-as-code cloud-infrastructure-management service of claim 9 wherein a state-module-function call includes:
a name of the state module;
a name of the function within the state module; and
a set of one or more key/attribute-value pairs that include key/attribute-value pairs that contain argument values for the function call.

11. The infrastructure-as-code cloud-infrastructure-management service of claim 9 wherein the describe state module includes a describe function that generates a configuration file that specifies the current state of a target server running a server-side cloud-infrastructure-management service.

12. The infrastructure-as-code cloud-infrastructure-management service of claim 11 wherein implementation of the describe function included in the describe state module includes addition of one or more information-returning functions to each state module, each information-returning function returning key/argument-value pairs for state-module function arguments in configuration-and-management data files and additional information needed for constructing configuration-and-management data files that represent the current state of a target server.

13. The infrastructure-as-code cloud-infrastructure-management service of claim 12 wherein the describe state module includes:
the describe function, which generates a configuration-and-management data file for a specified state module and target minion;
an all function, which generates a configuration-and-management data file for all state modules relevant to a specified target minion; and
a top function, which generates a top file for the configuration-and-management data files generated by the describe and all functions for a particular target minion. the top file matching relevant states to particular minions.

14. A method that enhances an infrastructure-as-code cloud-infrastructure-management service that manages cloud infrastructure provided by a distributed cloud-computing system, the method comprising:
adding of one or more information-returning functions to state module maintained by the infrastructure-as-code cloud-infrastructure-management service; and
adding a describe state module to state module maintained by the infrastructure-as-code cloud-infrastructure-management service which includes a describe function that generates a configuration file that specifies the current state of a target server running a server-side cloud-infrastructure-management service.

15. The method of claim 14 wherein the infrastructure-as-code cloud-infrastructure-management service comprises:
a master, implemented in one or more computer systems, each containing one or more processors, one or more memories, and one or more data-storage devices;
multiple minions, each minion
running within a server within the distributed cloud-computing system,
executing functions within execution modules in response to jobs issued by the master,
returning response information resulting from function executions to the master, and
including a grains interface and stored information referred to as “grains;”
a mine, maintained by the master, which contains a constantly updated collection of grains provided by the minions; and
a collection of pillars, maintained by the master, that together comprise a database of stored information, including execution modules execution modules and one or more state trees, portions of which can be selectively targeted for export to particular sets of minions.

16. The method of claim 15 wherein the infrastructure-as-code cloud-infrastructure-management service of claim 1 wherein cloud infrastructure within the distributed cloud-computing system is configured and managed based on configuration-and-management information encoded in a set of configuration-and-management data files.

17. The method of claim 16 wherein the master applies states, contained in stored configuration-and-management data files, to minions by issuing state-application jobs to an event bus, the jobs detected by the minions, a minion using targeting information included in the job to decide whether to execute the job and, when the minion decided to execute the job, the minion accesses the configuration-and-management data files within a state tree to determine a relevant set of states to enforce and then locally executes execution-module functions to execute state-module functions specified in state definitions within the configuration-and-management data files, as needed, to ensure that a local configuration of the minion corresponds to a configuration specified in the configuration-and-management data files.

18. The method of claim 17 wherein a state tree is a hierarchical file-directory structure that includes a root directory and underlying subdirectories, each subdirectory containing configuration-and-management data files associated with a particular state module, with the state modules generally corresponding to different types of computational resources that are configured and managed by the master.

19. The method of claim 18
wherein a configuration-and-management data file contains one or more state definitions, each state definition including
a state identifier, and
one or more state-module-function calls; and
wherein a state-module-function call includes
a name of the state module,
a name of the function within the state module, and
a set of one or more key/attribute-value pairs that include key/attribute-value pairs that contain argument values for the function call.

20. The method of claim 19 wherein implementation of the describe function included in the describe state module includes addition of one or more information-returning functions to each state module, each in information-returning function returning key/argument-value pairs for state-module function arguments in configuration-and-management data files and additional information needed for constructing configuration-and-management data files that represent the current state of a target server.

21. The method of claim 12 wherein the describe state module includes:
the describe function, which generates a configuration-and-management data file for a specified state module and target minion;
an all function, which generates a configuration-and-management data file for all state modules relevant to a specified target minion; and
a top function, which generates a top file for the configuration-and-management data files generated by the describe and all functions for a particular target minion, the top file matching relevant states to particular minions.

22. A physical data-storage device encoded with processor instructions that, when executed by one or more processors within one or more computer systems, each containing one or more processors, one or more memories, and one or more data-storage devices, control the one or more computer systems to enhance an infrastructure-as-code cloud-infrastructure-management service that manages cloud infrastructure provided by a distributed cloud-computing system by:
adding of one or more information-returning functions to state module maintained by the infrastructure-as-code cloud-infrastructure-management service; and
adding a describe state module to state module maintained by the infrastructure-as-code cloud-infrastructure-management service which includes a describe function that generates a configuration file that specifies the current state of a target server running a server-side cloud-infrastructure-management service.
